(19) United States
(12) Patent Application Publication
(10) Pub. No.: US 2025/0392185 A1
(43) Pub. Date: Dec. 25, 2025

(54) STATOR FOR ROTATING ELECTRIC MACHINE

(71) Applicant: KABUSHIKI KAISHA TOYOTA JIDOSHOKKI, Kariya-shi (JP)

(72) Inventors: Shuji TAKIMOTO, Kariya-shi (JP); Hiroyuki OHASHI, Kariya-shi (JP); Keisuke ISOBE, Kariya-shi (JP)

(73) Assignee: KABUSHIKI KAISHA TOYOTA JIDOSHOKKI, Kariya-shi (JP)

(21) Appl. No.: 19/229,318

(22) Filed: Jun. 5, 2025

(30) Foreign Application Priority Data
Jun. 21, 2024 (JP) 2024-100102

(51) Int. Cl. H02K 3/52

(52) U.S. Cl. CPC H02K 3/522; H02K 2203/06; H02K 2203/12

(57) ABSTRACT

A stator of a rotating electric machine includes three-phase coils and a stator core having a tubular yoke and multiple teeth. The coil of each phase includes four or more spool portions formed by a winding wound in a concentrated manner around every third one of the teeth in the circumferential direction, and a connection wire, a winding-start lead wire, and a winding-end lead wire, which are portions of the winding. All the connection wires of the three-phase coils extend in the same direction along the circumferential direction from one to the other of the two spool portions forming the coil set. The winding-start lead wires of the three-phase coils or the winding-end lead wires of the three-phase coils are electrically connected to each other to form a neutral point.

### CROSS-REFERENCE TO RELATED APPLICATIONS

This application is based upon and claims the benefit of priority from Japanese Patent Application No. 2024-100102, filed on Jun. 21, 2024, the entire contents of which are incorporated herein by reference.

### BACKGROUND

### 1. Field

The present disclosure relates to a stator for a rotating electric machine.

### 2. Description of Related Art

As disclosed, for example, in Japanese Laid-Open Patent Publication No. 2009-213343, a stator for a rotating electric machine includes a stator core and three-phase coils. The stator core includes a tubular yoke and teeth. The teeth are spaced apart from each other in the circumferential direction of the yoke. Each of the teeth extends from a circumferential surface of the yoke in a radial direction of the yoke. The coil of each phase has multiple spool portions formed by a winding wound around the teeth in a concentrated manner. The spool portions are connected in series via connection wires, which are sections of the winding.

In some cases, three connection wires of the coil of three phases overlap with one another in the axial direction of the yoke. As a result, the axial dimension of the yoke in the stator may be increased. Therefore, it is desired to reduce the axial size of the yoke in the stator.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a stator for a rotating electric machine includes three-phase coils and a stator core including a tubular yoke and multiple teeth arranged to be spaced apart from each other in a circumferential direction of the yoke. Each of the teeth extends from a circumferential surface of the yoke in a radial direction of the yoke. The coil of each phase includes four or more spool portions formed by a winding wound in a concentrated manner around every third one of the teeth in the circumferential direction, and a connection wire, a winding-start lead wire, and a winding-end lead wire, which are portions of the winding. Multiple coil sets are defined in the coil of each phase. Each of the multiple coil sets is formed by connecting two of the four or more spool portions in series via the connection wire. The two spool portions are arranged such that two of the teeth are present therebetween in the circumferential direction. The coil of each phase is formed by connecting the multiple coil sets in parallel. In the coil of each phase, the winding-start lead wire is led out from one of the two spool portions forming the coil set, and the winding-end lead wire is led out from the other of the two spool portions forming the coil set. All the connection wires of the three-phase coils extend in the same direction along the circumferential direction from one to the other of the two spool portions forming the coil set. The winding-start lead wires of the three-phase coils are respectively led out from spool portions that are wound around teeth with one tooth interposed therebetween in the circumferential direction. The winding-start lead wires of the three-phase coils or the winding-end lead wires of the three-phase coils are electrically connected to each other to form a neutral point.

Other features and aspects will be apparent from the following detailed description, the drawings, and the claims.

### BRIEF DESCRIPTION OF THE DRAWINGS

FIG. 1 is a cross-sectional view of a stator and a rotor of a rotating electric machine according to an embodiment.

FIG. 2 is an exploded perspective view of a stator core and two insulators of the stator shown in FIG. 1.

FIG. 3 is a perspective view of the stator shown in FIG. 1.

FIG. 4 is another perspective view of the stator shown in FIG. 1.

FIG. 5 is a developed view schematically showing a relationship among an insulator, teeth, and windings in the stator shown in FIG. 1.

FIG. 6 is a cross-sectional view of a winding of the stator shown in FIG. 1.

FIG. 7 is a cross-sectional view of a winding-end lead wire of the stator shown in FIG. 1.

FIG. 8 is a perspective view showing a state in which a winding-end lead wire of the stator shown in FIG. 1 is hooked and fixed.

FIG. 9 is a developed view schematically showing a relationship among an insulator, teeth, and windings in a stator according to a modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

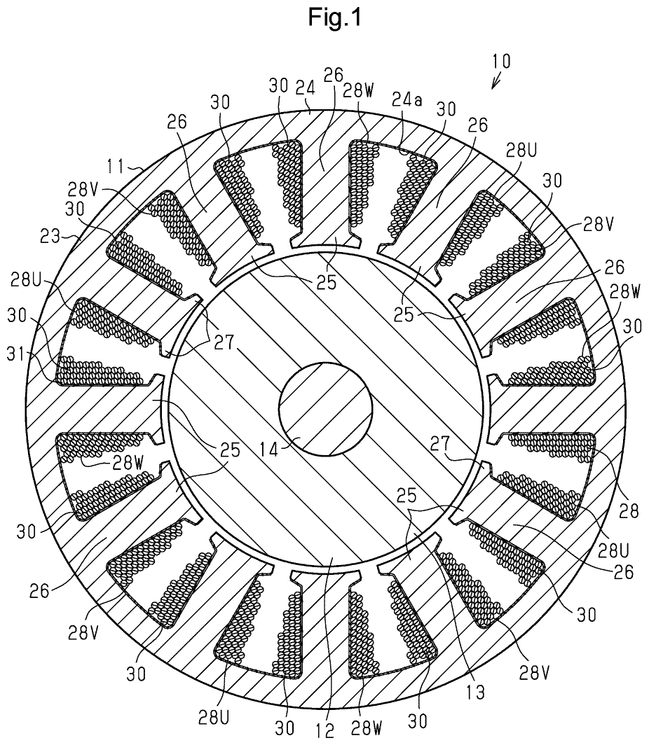

A stator 11 for a rotating electric machine 10 according to an embodiment will now be described with reference to FIGS. 1 to 8.

### Basic Structure of the Rotating Electric Machine

As shown in FIG. 1, the rotating electric machine 10 includes the stator 11 and a rotor 12. The stator 11 is tubular. The rotor 12 is located on the inner side of the stator 11. The rotor 12 includes a cylindrical rotor core 13 and permanent magnets (not shown) embedded in the rotor core 13. The rotor core 13 is fixed to a rotary shaft 14. The rotor core 13 is configured to rotate integrally with the rotary shaft 14.

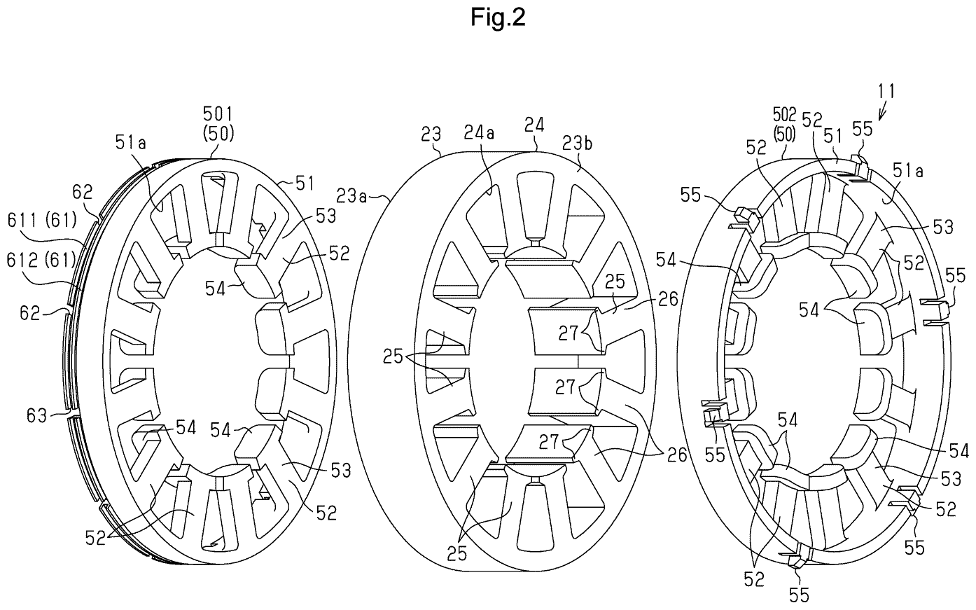

As shown in FIGS. 1 and 2, the stator 11 includes a stator core 23. The stator core 23 includes a yoke 24 and multiple teeth 25. The yoke 24 is cylindrical. The teeth 25 extend in a radial direction of the yoke 24 from an inner circumferential surface 24a, which is a circumferential surface of the yoke 24. The teeth 25 are spaced apart from each other in a circumferential direction of the yoke 24. The teeth 25 are disposed at equal intervals in the circumferential direction of the yoke 24. The circumferential direction of the yoke 24 corresponds to the circumferential direction of the stator core 23. Each tooth 25 extends from the inner circumferential surface 24a of the yoke 24 toward the axis of the stator core 23. In the present embodiment, the stator core 23 includes twelve teeth 25. Although the number of the teeth 25 is not particularly limited, the number of the teeth 25 is a multiple of three.

As shown in FIG. 2, opposite end faces of the yoke 24 in the axial direction are flat. Opposite end faces of each tooth 25 in the axial direction of the yoke 24 are flat. The length of the yoke 24 in the axial direction is equal to the length of each tooth 25 in the axial direction of the yoke 24. An end face of the yoke 24 located at a first side in the axial direction is located on the same plane as an end face of each tooth 25 located at the first side in the axial direction of the yoke 24. An end face of the yoke 24 located at a second side in the axial direction is located on the same plane as an end face of each tooth 25 located at the second side in the axial direction of the yoke 24.

The end face of the yoke 24 located at the first side in the axial direction and the end faces of the teeth 25 located at the first side in the axial direction of the yoke 24 form a first core end face 23a, which is an end face of the stator core 23 located at the first side in the axial direction of the yoke 24. The end face of the yoke 24 located at the second side in the axial direction and the end faces of the teeth 25 located at the second side in the axial direction of the yoke 24 form a second core end face 23b, which is an end face of the stator core 23 located at the second side in the axial direction of the yoke 24. Therefore, the stator core 23 has the first core end face 23a, which is an end face located at the first side in the axial direction of the yoke 24, and the second core end face 23b, which is an end face located at the second side in the axial direction of the yoke 24.

As shown in FIGS. 1 and 2, each tooth 25 includes a tooth extension 26 and two tooth flanges 27. The tooth extension 26 is a thin plate that extends from the inner circumferential surface 24a of the yoke 24. The tooth extension 26 extends from the first core end face 23a to the second core end face 23b of the stator core 23. The tooth flanges 27 project from the end of the tooth extension 26 on the side opposite to the end connected to the yoke 24 and toward the opposite sides in the circumferential direction of the yoke 24.

As shown in FIG. 1, the stator 11 includes three-phase coils 28. In the following description, the three-phase coils 28 may be referred to respectively as a U-phase coil 28U, a V-phase coil 28V, and a W-phase coil 28W.

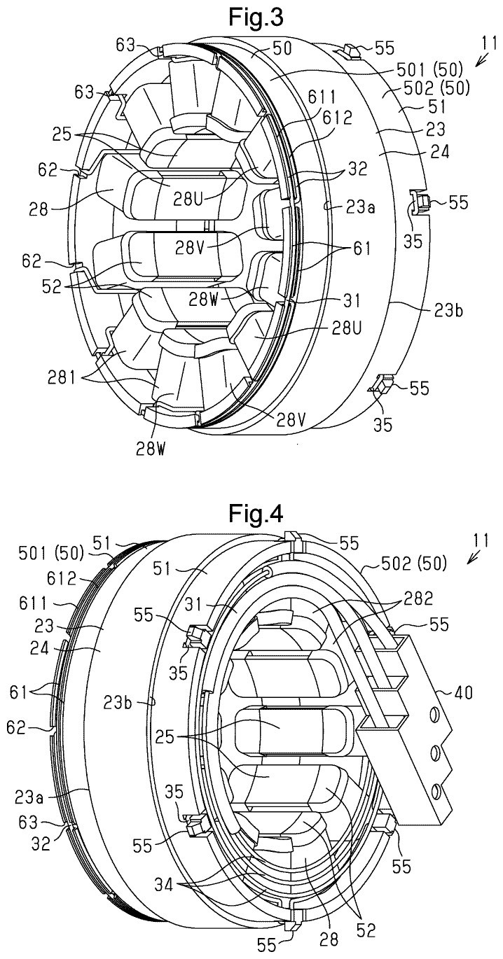

As shown in FIGS. 3 and 4, the stator 11 includes first coil ends 281 and second coil ends 282. The first coil ends 281 are parts of the coils 28 and protrude from the first core end face 23a. The second coil ends 282 are parts of the coils 28 and protrude from the second core end face 23b.

### Insulators

As shown in FIG. 2, the stator 11 includes two insulators 50. Each insulator 50 is tubular. Each insulator 50 is made of, for example, plastic. Each insulator 50 insulates the coils 28 from the stator core 23.

Each insulator 50 includes an insulator base 51 and insulator tooth portions 52. The insulator base 51 is cylindrical. The insulators 50 are disposed on the stator core 23 with the axes of the insulator bases 51 agreeing with the axis of the yoke 24. The insulator bases 51 are disposed at positions overlapping with the yoke 24 in the axial direction of the yoke 24. The circumferential direction of each insulator base 51 agrees with the circumferential direction of the yoke 24.

One of the insulators 50 is disposed to face the first core end face 23a of the stator core 23 while being in contact with the first core end face 23a. The other of the two insulators 50 is disposed to face the second core end face 23b while being in contact with the second core end face 23b of the stator core 23. In the following description, one of the two insulators 50 that is disposed to face the first core end face 23a of the stator core 23 may be referred to as a first insulator 501, and the insulator 50 disposed to face the second core end face 23b may be referred to as a second insulator 502. The outer diameter of the insulator base 51 is smaller than the outer diameter of the yoke 24. The inner diameter of the insulator base 51 is equal to the inner diameter of the yoke 24.

Each insulator tooth portion 52 extends in the radial direction of the insulator base 51 from an inner circumferential surface 51a of the insulator base 51. The insulator tooth portions 52 are spaced apart from each other in the circumferential direction of the insulator base 51. The insulator tooth portions 52 are disposed at equal intervals in the circumferential direction of the insulator base 51. Each insulator tooth portion 52 extends from the inner circumferential surface 51a of the insulator base 51 toward the axis of the insulator base 51. In the present embodiment, each insulator 50 includes twelve insulator tooth portions 52. The number of the insulator tooth portions 52 is the same as the number of the teeth 25 of the stator core 23.

Each insulator tooth portion 52 includes an insulator extension 53 and an insulator flange 54. Each insulator extension 53 has the shape of a post that extends from the inner circumferential surface 51a of the insulator base 51. The width of each insulator extension 53 in the circumferential direction of the insulator base 51 is equal to the width of each tooth extension 26 in the circumferential direction of the yoke 24. Each insulator extension 53 is in contact with the corresponding tooth 25. The insulator flange 54 projects parallel to the insulator base 51 from the end of the insulator extension 53 on the side opposite to the end the connected to the insulator base 51.

As shown in FIG. 3, the first insulator 501 provides insulation between the first coil ends 281 and the first core end face 23a. Accordingly, the first insulator 501 provides insulation between the coils 28 and the first core end face 23a.

As shown in FIG. 4, the second insulator 502 provides insulation between the second coil ends 282 and the second core end face 23b. Accordingly, the second insulator 502 provides insulation between the coils 28 and the second core end face 23b.

### Connection Wire Receiving Grooves

As shown in FIG. 2, two connection wire receiving grooves 61 are formed in an outer circumferential surface that is a circumferential surface of the insulator base 51 of the first insulator 501. The two connection wire receiving grooves 61 are arranged side by side in the axial direction of the insulator base 51. Each connection wire receiving groove 61 extends in the circumferential direction of the yoke 24. Each connection wire receiving groove 61 extends over the entire circumference of the outer circumferential surface of the insulator base 51. Each connection wire receiving groove 61 does not extend through the insulator base 51 in the radial direction.

In the following description, one of the two connection wire receiving grooves 61 that is disposed at a position farther from the stator core 23 may be referred to as a first connection wire receiving groove 611. Also, one of the two connection wire receiving grooves 61 that is disposed at a position closer to the stator core 23 may be referred to as a second connection wire receiving groove 612.

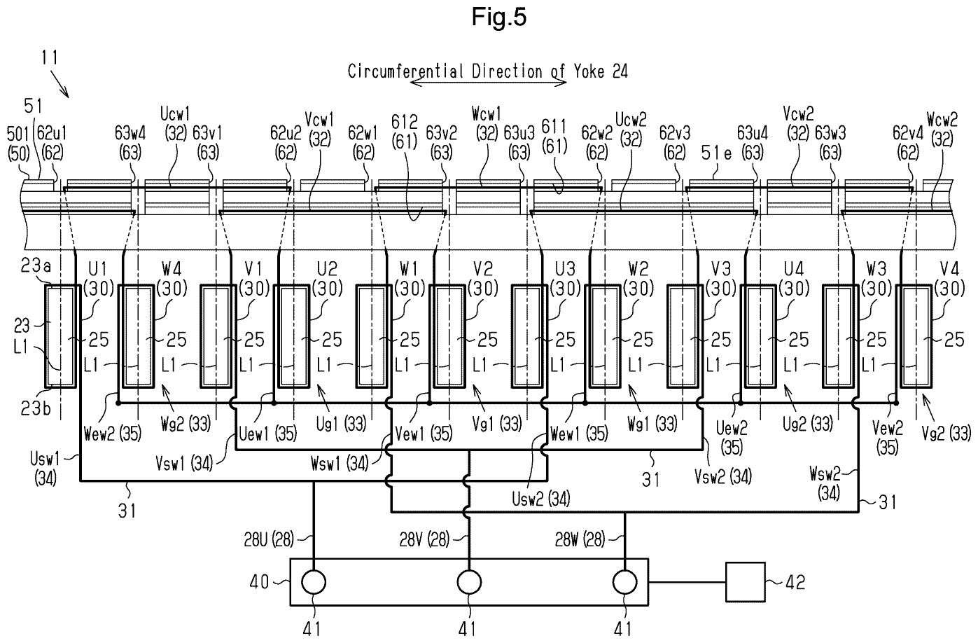

As shown in FIG. 5, six first through-grooves 62 and six second through-grooves 63 are formed in the insulator base 51 of the first insulator 501. The first through-grooves 62 and the second through-grooves 63 extend through the insulator base 51 in the radial direction. The total number of the first through-grooves 62 and the second through-grooves 63 is equal to the number of the teeth 25. Each of the first through-grooves 62 and each of the second through-grooves 63 extend in the axial direction of the insulator base 51 from an end face 51e of the insulator base 51 that is located on the side opposite to the stator core 23.

The lengths of the first through-grooves 62 from the end face 51e of the insulator base 51 are shorter than the lengths of the second through-grooves 63 from the end face 51e of the insulator base 51. Each first through-groove 62 communicates with the first connection wire receiving groove 611. Each first through-groove 62 divides the first connection wire receiving groove 611 in the circumferential direction of the insulator base 51. Each second through-groove 63 extends across the first connection wire receiving groove 611 and communicates with the second connection wire receiving groove 612. Each second through-groove 63 divides the first connection wire receiving groove 611 and the second connection wire receiving groove 612 in the circumferential direction of the insulator base 51.

As shown in FIG. 2, each of the first through-grooves 62 and each of the second through-grooves 63 overlap with the corresponding insulator extension 53 in the radial direction of the insulator base 51 when viewed in the axial direction of the insulator base 51. As shown in FIG. 5, each of the first through-grooves 62 and each of the second through-grooves 63 are arranged on an axis L1 of the corresponding tooth 25 when viewed in the radial direction of the insulator base 51. The axis L1 of each tooth 25 is a straight line that is parallel to the axis of the yoke 24 and extends through the center of the tooth 25 in the circumferential direction of the yoke 24. Thus, the first through-grooves 62 and the second through-grooves 63 are arranged at positions corresponding to the teeth 25 in the circumferential direction of the insulator base 51.

The six first through-grooves 62 are arranged such that two first through-grooves 62 are adjacent to each other in the circumferential direction of the insulator base 51. The six second through-grooves 63 are arranged such that two second through-grooves 63 are adjacent to each other in the circumferential direction of the insulator base 51. A set of two first through-grooves 62 adjacent to each other in the circumferential direction of the insulator base 51 and a set of two second through-grooves 63 adjacent to each other in the circumferential direction of the insulator base 51 are alternately arranged in the circumferential direction of the insulator base 51.

### Coil of Each Phase

The U-phase coil 28U, the V-phase coil 28V, and the W-phase coil 28W each include four spool portions 30. Each spool portion 30 is formed by a winding 31 wound in a concentrated manner so as to collectively surround on of the tooth extensions 26 and the corresponding two insulator extensions 53, which are arranged side by side in the axial direction of the stator 11. In FIG. 5, for illustrative clarity, the state in which the windings 31 are wound around the insulator extensions 53 is omitted. FIG. 5 schematically shows only a state in which the windings 31 are wound around the teeth 25.

In the following description, the four spool portions 30 of the U-phase coil 28U may be referred to as a first spool portion U1, a second spool portion U2, a third spool portion U3, and a fourth spool portion U4, respectively. Further, the four spool portions 30 of the V-phase coil 28V may be referred to as a first spool portion V1, a second spool portion V2, a third spool portion V3, and a fourth spool portion V4, respectively. Also, the four spool portions 30 of the W-phase coil 28W may be referred to as a first spool portion W1, a second spool portion W2, a third spool portion W3, and a fourth spool portion W4, respectively.

The first spool portion U1, the second spool portion U2, the third spool portion U3, and the fourth spool portion U4 are formed by the winding 31 wound in a concentrated manner around every third one of the teeth 25 in the circumferential direction of the yoke 24. The first spool portion U1, the second spool portion U2, the third spool portion U3, and the fourth spool portion U4 are arranged in that order in the circumferential direction of the yoke 24, and two teeth 25 are present between each adjacent pair of the first spool portion U1, the second spool portion U2, the third spool portion U3, and the fourth spool portion U4.

The first spool portion V1, the second spool portion V2, the third spool portion V3, and the fourth spool portion V4 are formed by the winding 31 wound in a concentrated manner around every third one of the teeth 25 in the circumferential direction of the yoke 24. The first spool portion V1, the second spool portion V2, the third spool portion V3, and the fourth spool portion V4 are arranged in that order in the circumferential direction of the yoke 24, and two teeth 25 are present between each adjacent pair of the first spool portion V1, the second spool portion V2, the third spool portion V3, and the fourth spool portion V4.

The first spool portion W1, the second spool portion W2, the third spool portion W3, and the fourth spool portion W4 are formed by the winding 31 wound in a concentrated manner around every third one of the teeth 25 in the circumferential direction of the yoke 24. The first spool portion W1, the second spool portion W2, the third spool portion W3, and the fourth spool portion W4 are arranged in that order in the circumferential direction of the yoke 24, and two teeth 25 are present between each adjacent pair of the first spool portion W1, the second spool portion W2, the third spool portion W3, and the fourth spool portion W4.

As described above, the coil 28 of each phase includes four spool portions 30, which are formed by the corresponding winding 31 wound in a concentrated manner around every third one of the teeth 25 in the circumferential direction of the yoke 24.

The coil 28 of each phase includes two connection wires 32. The connection wires 32 are portions of the winding 31. In the following description, the two connection wires 32 of the U-phase coil 28U may be referred to as a first connection wire Ucw1 and a second connection wire Ucw2, respectively. The two connection wires 32 of the V-phase coil 28V may be referred to as a first connection wire Vcw1 and a second connection wire Vcw2, respectively. Further, the two connection wires 32 of the W-phase coil 28W may be referred to as a first connection wire Wcw1 and a second connection wire Wcw2, respectively.

The U-phase coil 28U includes a first coil set Ug1 and a second coil set Ug2. The first coil set Ug1 is formed by connecting the first spool portion U1 and the second spool portion U2 in series via the first connection wire Ucw1. The first spool portion U1 and the second spool portion U2 are two spool portions 30 that are arranged with two teeth 25 interposed therebetween in the circumferential direction of the yoke 24. The second coil set Ug2 is formed by connecting the third spool portion U3 and the fourth spool portion U4 in series via the second connection wire Ucw2. The third spool portion U3 and the fourth spool portion U4 are two spool portions 30 that are arranged with two teeth 25 interposed therebetween in the circumferential direction of the yoke 24. The U-phase coil 28U is formed by connecting the first coil set Ug1 and the second coil set Ug2 in parallel.

The V-phase coil 28V includes a first coil set Vg1 and a second coil set Vg2. The first coil set Vg1 is formed by connecting the first spool portion V1 and the second spool portion V2 in series via the first connection wire Vcw1. The first spool portion V1 and the second spool portion V2 are two spool portions 30 that are arranged with two teeth 25 interposed therebetween in the circumferential direction of the yoke 24. The second coil set Vg2 is formed by connecting the third spool portion V3 and the fourth spool portion V4 in series via the second connection wire Vcw2. The third spool portion V3 and the fourth spool portion V4 are two spool portions 30 that are arranged with two teeth 25 interposed therebetween in the circumferential direction of the yoke 24. The V-phase coil 28V is formed by connecting the first coil set Vg1 and the second coil set Vg2 in parallel.

The W-phase coil 28W includes a first coil set Wg1 and a second coil set Wg2. The first coil set Wg1 is formed by connecting the first spool portion W1 and the second spool portion W2 in series via the first connection wire Wcw1. The first spool portion W1 and the second spool portion W2 are two spool portions 30 that are arranged with two teeth 25 interposed therebetween in the circumferential direction of the yoke 24. The second coil set Wg2 is formed by connecting the third spool portion W3 and the fourth spool portion W4 in series via the second connection wire Wcw2. The third spool portion W3 and the fourth spool portion W4 are two spool portions 30 that are arranged with two teeth 25 interposed therebetween in the circumferential direction of the yoke 24. The W-phase coil 28W is formed by connecting the first coil set Wg1 and the second coil set Wg2 in parallel.

In the following description, the first coil set Ug1, the second coil set Ug2, the first coil set Vg1, the second coil set Vg2, the first coil set Wg1, and the second coil set Wg2 may be simply referred to as coil sets 33.

As described above, two coil sets 33 are defined in the coil 28 of each phase. Each coil set 33 is formed by connecting in series two of the four spool portions 30 that are disposed with two teeth 25 interposed therebetween in the circumferential direction of the yoke 24 via the connection wire 32. The coil 28 of each phase is formed by connecting the two coil sets 33 in parallel.

In the U-phase coil 28U, a first winding-start lead wire Usw1, which is a portion of the winding 31, is led out from the first spool portion U1, which forms the first coil set Ug1. In the U-phase coil 28U, a first winding-end lead wire Uew1, which is a portion of the winding 31, is led out from the second spool portion U2, which forms the first coil set Ug1.

In the U-phase coil 28U, a second winding-start lead wire Usw2, which is a portion of the winding 31, is led out from the third spool portion U3, which forms the second coil set Ug2. In the U-phase coil 28U, a second winding-end lead wire Uew2, which is a portion of the winding 31, is led out from the fourth spool portion U4, which forms the second coil set Ug2.

In the V-phase coil 28V, a first winding-start lead wire Vsw1, which is a portion of the winding 31, is led out from the first spool portion V1, which forms the first coil set Vg1. In the V-phase coil 28V, a first winding-end lead wire Vew1, which is a portion of the winding 31, is led out from the second spool portion V2, which forms the first coil set Vg1.

In the V-phase coil 28V, a second winding-start lead wire Vsw2, which is a portion of the winding 31, is led out from the third spool portion V3, which forms the second coil set Vg2. In the V-phase coil 28V, a second winding-end lead wire Vew2, which is a portion of the winding 31, is led out from the fourth spool portion V4, which forms the second coil set Vg2.

In the W-phase coil 28W, a first winding-start lead wire Wsw1, which is a portion of the winding 31, is led out from the first spool portion W1, which forms the first coil set Wg1. In the W-phase coil 28W, a first winding-end lead wire Wew1, which is a portion of the winding 31, is led out from the second spool portion W2, which forms the first coil set Wg1.

In the W-phase coil 28W, a second winding-start lead wire Wsw2, which is a portion of the winding 31, is led out from the third spool portion W3, which forms the second coil set Wg2. In the W-phase coil 28W, a second winding-end lead wire Wew2, which is a portion of the winding 31, is led out from the fourth spool portion W4, which forms the second coil set Wg2.

In the following description, the first winding-start lead wire Usw1, the second winding-start lead wire Usw2, the first winding-start lead wire Vsw1, the second winding-start lead wire Vsw2, the first winding-start lead wire Wsw1, and the second winding-start lead wire Wsw2 may simply be referred to as winding-start lead wires 34. In the following description, the first winding-end lead wire Uew1, the second winding-end lead wire Uew2, the first winding-end lead wire Vew1, the second winding-end lead wire Vew2, the first winding-end lead wire Wew1, and the second winding-end lead wire Wew2 may simply be referred to as winding-end lead wires 35.

As described above, in the coil 28 of each phase, the winding-start lead wire 34 is led out from one of the two spool portions 30 forming the coil set 33, and the winding-end lead wire 35 is led out from the other of the two spool portions 30 forming the coil set 33.

The first spool portion V1 is a spool portion 30 wound around a tooth 25 that is located, with one tooth 25 interposed, relative to the first spool portion U1 in the circumferential direction of the yoke 24. The first spool portion W1 is a spool portion 30 wound around a tooth 25 that is located, with one tooth 25 interposed, relative to the first spool portion V1 in the circumferential direction of the yoke 24. The third spool portion U3 is a spool portion 30 wound around a tooth 25 that is located, with one tooth 25 interposed, relative to the first spool portion W1 in the circumferential direction of the yoke 24. The third spool portion V3 is a spool portion 30 wound around a tooth 25 that is located, with one tooth 25 interposed, relative to the third spool portion U3 in the circumferential direction of the yoke 24. The third spool portion W3 is a spool portion 30 wound around a tooth 25 that is located, with one tooth 25 interposed, relative to the third spool portion V3 in the circumferential direction of the yoke 24.

Therefore, the first winding-start lead wire Usw1, the second winding-start lead wire Usw2, the first winding-start lead wire Vsw1, the second winding-start lead wire Vsw2, the first winding-start lead wire Wsw1, and the second winding-start lead wire Wsw2 are respectively led out from spool portions 30 that are wound around teeth 25 with one tooth 25 interposed therebetween in the circumferential direction of the yoke 24. In this manner, the winding-start lead wires 34 of the three-phase coils 28 are respectively led out from spool portions 30 that are wound around teeth 25 with one tooth 25 interposed therebetween in the circumferential direction of the yoke 24.

The first coil set Ug1 is a coil set 33 that includes the first spool portion U1, which is positioned, with one spool portion interposed therebetween, in the circumferential direction of the yoke 24 relative to the third spool portion W3. The winding-start lead wire Wsw2 of the second coil set Wg2, which is one coil set 33, is led out from the third spool portion W3. The first coil set Vg1 is a coil set 33 that includes the first spool portion V1, which is positioned, with one spool portion interposed therebetween, in the circumferential direction of the yoke 24 relative to the first spool portion U1. The winding-start lead wire Usw1 of the first coil set Ug1, which is one coil set 33, is led out from the first spool portion U1. The first coil set Wg1 is a coil set 33 that includes the first spool portion W1, which is positioned, with one spool portion interposed therebetween, in the circumferential direction of the yoke 24 relative to the first spool portion V1. The winding-start lead wire Vsw1 of the first coil set Vg1, which is one coil set 33, is led out from the first spool portion V1. The second coil set Ug2 is a coil set 33 that includes the third spool portion U3, which is positioned, with one spool portion interposed therebetween, in the circumferential direction of the yoke 24 relative to the first spool portion W1. The winding-start lead wire Wsw1 of the first coil set Wg1, which is one coil set 33, is led out from the first spool portion W1. The second coil set Vg2 is a coil set 33 that includes the third spool portion V3, which is positioned, with one spool portion interposed therebetween, in the circumferential direction of the yoke 24 relative to the third spool portion U3. The winding-start lead wire Usw2 of the second coil set Ug2, which is one coil set 33, is led out from the third spool portion U3. The second coil set Wg2 is a coil set 33 that includes the third spool portion W3, which is positioned, with one spool portion interposed therebetween, in the circumferential direction of the yoke 24 relative to the third spool portion V3. The winding-start lead wire Vsw2 of the second coil set Vg2, which is one coil set 33, is led out from the third spool portion V3.

The axis L1 of the tooth 25 around which the winding 31 forming the first spool portion U1 is wound extends through one of the six first through-grooves 62 when viewed in the radial direction of the insulator base 51. Therefore, one of the six first through-grooves 62 is disposed at a position, in the circumferential direction of the yoke 24, corresponding to the tooth 25 around which the winding 31 forming the first spool portion U1 is wound. In the following description, this first through-groove 62 may be referred to as a first through-groove 62u1.

The axis L1 of the tooth 25 around which the winding 31 forming the second spool portion U2 is wound extends through one of the six first through-grooves 62 when viewed in the radial direction of the insulator base 51. Therefore, one of the six first through-grooves 62 is disposed at a position, in the circumferential direction of the yoke 24, corresponding to the tooth 25 around which the winding 31 forming the second spool portion U2 is wound. In the following description, this first through-groove 62 may be referred to as a first through-groove 62u2.

The first connection wire Ucw1 is led out from the first spool portion U1 toward the first side in the axial direction of the yoke 24 across the first core end face 23a, and is led out to the outer side in the radial direction of the yoke 24 relative to the insulator base 51 via the first through-groove 62u1. The first connection wire Ucw1, which is led out from the first through-groove 62u1, is bent toward one side in the circumferential direction of the yoke 24 and is received in the first connection wire receiving groove 611. The first connection wire Ucw1, which is received in the first connection wire receiving groove 611, extends in the circumferential direction of the yoke 24 while traversing two second through-grooves 63, and is connected to the second spool portion U2 via the subsequently positioned first through-groove 62u2.

The axis L1 of the tooth 25 around which the winding 31 forming the first spool portion V1 is wound extends through one of the six second through-grooves 63 when viewed in the radial direction of the insulator base 51. Therefore, one of the six second through-grooves 63 is disposed at a position, in the circumferential direction of the yoke 24, corresponding to the tooth 25 around which the winding 31 forming the first spool portion V1 is wound. In the following description, this second through-groove 63 may be referred to as a second through-groove 63v1.

The axis L1 of the tooth 25 around which the winding 31 forming the second spool portion V2 is wound extends through one of the six second through-grooves 63 when viewed in the radial direction of the insulator base 51. Therefore, one of the six second through-grooves 63 is disposed at a position, in the circumferential direction of the yoke 24, corresponding to the tooth 25 around which the winding 31 forming the second spool portion V2 is wound. In the following description, this second through-groove 63 may be referred to as a second through-groove 63v2.

The first connection wire Vcw1 is led out from the first spool portion V1 toward the first side in the axial direction of the yoke 24 across the first core end face 23a, and is led out to the outer side in the radial direction of the yoke 24 relative to the insulator base 51 via the second through-groove 63v1. The first connection wire Vcw1, which is led out from the second through-groove 63v1, is bent toward one side in the circumferential direction of the yoke 24 and is received in the second connection wire receiving groove 612. The first connection wire Vcw1, which is received in the second connection wire receiving groove 612, extends in the circumferential direction of the yoke 24 and is connected to the second spool portion V2 via the subsequently positioned second through-groove 63v2.

The axis L1 of the tooth 25 around which the winding 31 forming the first spool portion W1 is wound extends through one of the six first through-grooves 62 when viewed in the radial direction of the insulator base 51. Therefore, one of the six first through-grooves 62 is disposed at a position, in the circumferential direction of the yoke 24, corresponding to the tooth 25 around which the winding 31 forming the first spool portion W1 is wound. In the following description, this first through-groove 62 may be referred to as a first through-groove 62w1.

The axis L1 of the tooth 25 around which the winding 31 forming the second spool portion W2 is wound extends through one of the six first through-grooves 62 when viewed in the radial direction of the insulator base 51. Therefore, one of the six first through-grooves 62 is disposed at a position, in the circumferential direction of the yoke 24, corresponding to the tooth 25 around which the winding 31 forming the second spool portion W2 is wound. In the following description, this first through-groove 62 may be referred to as a first through-groove 62w2.

The first connection wire Wcw1 is led out from the first spool portion W1 toward the first side in the axial direction of the yoke 24 across the first core end face 23a, and is led out to the outer side in the radial direction of the yoke 24 relative to the insulator base 51 via the first through-groove 62w1. The first connection wire Wcw1, which is led out from the first through-groove 62w1, is bent toward one side in the circumferential direction of the yoke 24 and is received in the first connection wire receiving groove 611. The first connection wire Wcw1, which is received in the first connection wire receiving groove 611, extends in the circumferential direction of the yoke 24 while traversing two second through-grooves 63, and is connected to the second spool portion W2 via the subsequently positioned first through-groove 62w2.

The axis L1 of the tooth 25 around which the winding 31 forming the third spool portion U3 is wound extends through one of the six second through-grooves 63 when viewed in the radial direction of the insulator base 51. Therefore, one of the six second through-grooves 63 is disposed at a position, in the circumferential direction of the yoke 24, corresponding to the tooth 25 around which the winding 31 forming the third spool portion U3 is wound. In the following description, this second through-groove 63 may be referred to as a second through-groove 63u3.

The axis L1 of the tooth 25 around which the winding 31 forming the fourth spool portion U4 is wound extends through one of the six second through-grooves 63 when viewed in the radial direction of the insulator base 51. Therefore, one of the six second through-grooves 63 is disposed at a position, in the circumferential direction of the yoke 24, corresponding to the tooth 25 around which the winding 31 forming the fourth spool portion U4 is wound. In the following description, this second through-groove 63 may be referred to as a second through-groove 63u4.

The second connection wire Ucw2 is led out from the third spool portion U3 toward the first side in the axial direction of the yoke 24 across the first core end face 23a, and is led out to the outer side in the radial direction of the yoke 24 relative to the insulator base 51 via the second through-groove 63u3. The second connection wire Ucw2, which is led out from the second through-groove 63u3, is bent toward one side in the circumferential direction of the yoke 24 and is received in the second connection wire receiving groove 612. The second connection wire Ucw2, which is received in the second connection wire receiving groove 612, extends in the circumferential direction of the yoke 24 and is connected to the fourth spool portion U4 via the subsequently positioned second through-groove 63u4.

The axis L1 of the tooth 25 around which the winding 31 forming the third spool portion V3 is wound extends through one of the six first through-grooves 62 when viewed in the radial direction of the insulator base 51. Therefore, one of the six first through-grooves 62 is disposed at a position, in the circumferential direction of the yoke 24, corresponding to the tooth 25 around which the winding 31 forming the third spool portion V3 is wound. In the following description, this first through-groove 62 may be referred to as a first through-groove 62v3.

The axis L1 of the tooth 25 around which the winding 31 forming the fourth spool portion V4 is wound extends through one of the six first through-grooves 62 when viewed in the radial direction of the insulator base 51. Therefore, one of the six first through-grooves 62 is disposed at a position, in the circumferential direction of the yoke 24, corresponding to the tooth 25 around which the winding 31 forming the fourth spool portion V4 is wound. In the following description, this first through-groove 62 may be referred to as a first through-groove 62v4.

The second connection wire Vcw2 is led out from the third spool portion V3 toward the first side in the axial direction of the yoke 24 across the first core end face 23a, and is led out to the outer side in the radial direction of the yoke 24 relative to the insulator base 51 via the first through-groove 62v3. The second connection wire Vcw2, which is led out from the first through-groove 62v3, is bent toward one side in the circumferential direction of the yoke 24 and is received in the first connection wire receiving groove 611. The second connection wire Vcw2, which is received in the first connection wire receiving groove 611, extends in the circumferential direction of the yoke 24 while traversing two second through-grooves 63, and is connected to the fourth spool portion V4 via the subsequently positioned first through-groove 62v4.

The axis L1 of the tooth 25 around which the winding 31 forming the third spool portion W3 is wound extends through one of the six second through-grooves 63 when viewed in the radial direction of the insulator base 51. Therefore, one of the six second through-grooves 63 is disposed at a position, in the circumferential direction of the yoke 24, corresponding to the tooth 25 around which the winding 31 forming the third spool portion W3 is wound. In the following description, this second through-groove 63 may be referred to as a second through-groove 63w3.

The axis L1 of the tooth 25 around which the winding 31 forming the fourth spool portion W4 is wound extends through one of the six second through-grooves 63 when viewed in the radial direction of the insulator base 51. Therefore, one of the six second through-grooves 63 is disposed at a position corresponding to the tooth 25 around which the winding 31 forming the fourth spool portion W4 is wound. In the following description, this second through-groove 63 may be referred to as a second through-groove 63w4.

The second connection wire Wcw2 is led out from the third spool portion W3 toward the first side in the axial direction of the yoke 24 across the first core end face 23a, and is led out to the outer side in the radial direction of the yoke 24 relative to the insulator base 51 via the second through-groove 63w3. The second connection wire Wcw2, which is led out from the second through-groove 63w3, is bent toward one side in the circumferential direction of the yoke 24 and is received in the second connection wire receiving groove 612. The second connection wire Wcw2, which is received in the second connection wire receiving groove 612, extends in the circumferential direction of the yoke 24 and is connected to the fourth spool portion W4 via the subsequently positioned second through-groove 63w4.

In this manner, all the connection wires 32 of the three-phase coils 28 extend in the same direction in the circumferential direction of the yoke 24 from one to the other of the two spool portions 30 forming the corresponding coil set 33. In other words, all of the connection wires 32 of the three-phase coils 28 extend at one side in the circumferential direction of the yoke 24. The connection wire 32 of the coil 28 of each phase is led out across the first core end face 23a to the first side in the axial direction of the yoke 24, and extends in the circumferential direction of the yoke 24 while passing along the first side in the axial direction across the first core end face 23a. One of the two connection wire receiving grooves 61 guides the connection wire 32 of one coil set 33 in the circumferential direction of the yoke 24 while receiving the connection wire 32. The other of the two connection wire receiving grooves 61 guides, in the circumferential direction of the yoke 24, a connection wire 32 of another coil set 33, which includes a spool portion 30 that is located, with one spool portion 30 interposed therebetween, in the circumferential direction of the yoke 24 relative to the spool portion 30 from which the winding-start lead wire 34 of one coil set 33 is led out, while receiving the connection wire 32.

In a state of being received in the first connection wire receiving groove 611, the first connection wire Ucw1 extends in the circumferential direction of the yoke 24 while traversing the second through-groove 63v1 corresponding to the first spool portion V1. Also, in a state of being received in the first connection wire receiving groove 611, the first connection wire Ucw1 extends in the circumferential direction of the yoke 24 while traversing the second through-groove 63w4 corresponding to the fourth spool portion W4.

A portion of the first connection wire Ucw1 from the second through-groove 63v1, which corresponds to the first spool portion V1, to the first through-groove 62u2, which corresponds to the second spool portion U2, overlaps with the first connection wire Vcw1 in the axial direction of the yoke 24.

A portion of the first connection wire Ucw1 from the first through-groove 62u1, which corresponds to the first spool portion U1, to the second through-groove 63w4, which corresponds to the fourth spool portion W4, overlaps with the second connection wire Wcw2 in the axial direction of the yoke 24.

In a state of being received in the first connection wire receiving groove 611, the first connection wire Wcw1 extends in the circumferential direction of the yoke 24 while traversing the second through-groove 63v2 corresponding to the second spool portion V2. Also, in a state of being received in the first connection wire receiving groove 611, the first connection wire Wcw1 extends in the circumferential direction of the yoke 24 while traversing the second through-groove 63u3 corresponding to the third spool portion U3.

A portion of the first connection wire Wcw1 from the first through-groove 62w1, which corresponds to the first spool portion W1, to the second through-groove 63v2, which corresponds to the second spool portion V2, overlaps with the first connection wire Vcw1 in the axial direction of the yoke 24.

A portion of the first connection wire Wcw1 from the second through-groove 63u3, which corresponds to the third spool portion U3, to the first through-groove 62w2, which corresponds to the second spool portion W2, overlaps with the second connection wire Ucw2 in the axial direction of the yoke 24.

In a state of being received in the first connection wire receiving groove 611, the second connection wire Vcw2 extends in the circumferential direction of the yoke 24 while traversing the second through-groove 63u4 corresponding to the fourth spool portion U4. Also, in a state of being received in the first connection wire receiving groove 611, the second connection wire Vcw2 extends in the circumferential direction of the yoke 24 while traversing the second through-groove 63w3 corresponding to the third spool portion W3.

A portion of the second connection wire Vcw2 from the first through-groove 62v3, which corresponds to the third spool portion V3, to the second through-groove 63u4, which corresponds to the fourth spool portion U4, overlaps with the second connection wire Ucw2 in the axial direction of the yoke 24.

A portion of the second connection wire Vcw2 from the second through-groove 63w3, which corresponds to the third spool portion W3, to the first through-groove 62v4, which corresponds to the fourth spool portion V4, overlaps with the second connection wire Wcw2 in the axial direction of the yoke 24.

As described above, the maximum number of the connection wires 32 of the coils 28 of three phases that overlap with one another in the axial direction of the yoke 24 is two.

As shown in FIGS. 4 and 5, the stator 11 includes a cluster block 40, which accommodates connection terminals 41. In the U-phase coil 28U, the first winding-start lead wire Usw1 and the second winding-start lead wire Usw2 are led out toward the second side in the axial direction of the yoke 24 across the second core end face 23b, and are electrically connected to one of the connection terminals 41 accommodated in the cluster block 40 in a state of being connected in parallel with each other. In the V-phase coil 28V, the first winding-start lead wire Vsw1 and the second winding-start lead wire Vsw2 are led out toward the second side in the axial direction of the yoke 24 across the second core end face 23b, and are electrically connected to one of the connection terminals 41 accommodated in the cluster block 40 in a state of being connected in parallel with each other. In the W-phase coil 28W, the first winding-start lead wire Wsw1 and the second winding-start lead wire Wsw2 are led out toward the second side in the axial direction of the yoke 24 across the second core end face 23b, and are electrically connected to one of the connection terminals 41 accommodated in the cluster block 40 in a state of being connected in parallel with each other. The connection terminals 41 are electrically connected to a power supply 42.

Accordingly, the winding-start lead wires 34 of each of the three-phase coils 28 are led out toward the second side in the axial direction of the yoke 24 across the second core end face 23b, and are connected to the power supply 42 in a state of being connected in parallel with each other. In this manner, the winding-start lead wire 34 of the coil 28 of each phase is led out toward the second side in the axial direction of the yoke 24 across the second core end face 23b.

The first winding-end lead wire Uew1, the second winding-end lead wire Uew2, the first winding-end lead wire Vew1, the second winding-end lead wire Vew2, the first winding-end lead wire Wew1, and the second winding-end lead wire Wew2 are led out toward the second side in the axial direction of the yoke 24 across the second core end face 23b. In this manner, the winding-end lead wire 35 of the coil 28 of each phase is led out toward the second side in the axial direction of the yoke 24 across the second core end face 23b.

The first winding-end lead wire Uew1, the second winding-end lead wire Uew2, the first winding-end lead wire Vew1, the second winding-end lead wire Vew2, the first winding-end lead wire Wew1, and the second winding-end lead wire Wew2 are electrically connected to one another to form a neutral point. In this manner, the winding-end lead wires 35 of the three-phase coils 28 are electrically connected to one another to form a neutral point.

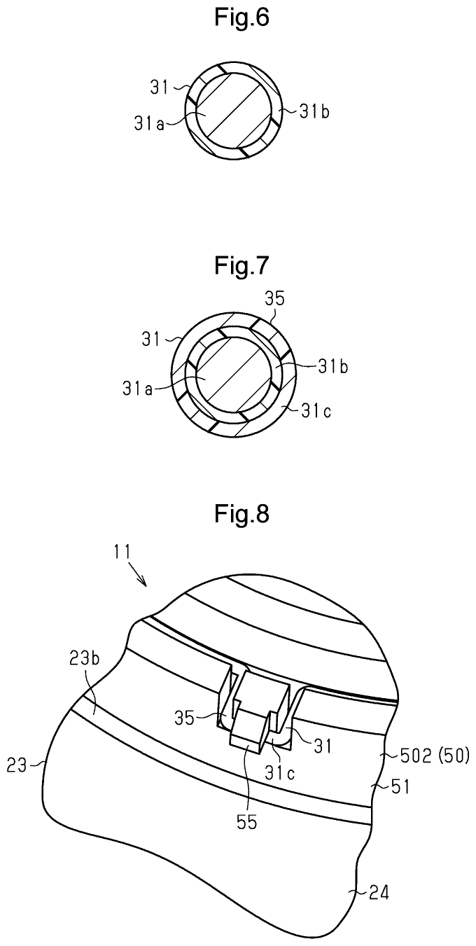

As shown in FIG. 6, each winding 31 includes a conductive wire 31a and a coating 31b provided on the outer circumference of the conductive wire 31a. The coating 31b is, for example, an enamel coating.

As shown in FIG. 7, each winding-end lead wire 35 includes an insulating member 31c, which covers the outer circumference of the coating 31b. Therefore, each winding-end lead wire 35 includes the conductive wire 31a, the coating 31b, and the insulating member 31c. The insulating member 31c is tubular and made of plastic.

As shown in FIG. 2, the insulator base 51 of the second insulator 502 includes six hook portions 55.

As shown in FIG. 8, each hook portion 55 is configured to hook and fix the winding-end lead wire 35 of the coil 28 of each phase. Each winding-end lead wire 35 is fixed to the insulator base 51 in a state in which tension is applied to the winding-end lead wire 35 by being hooked and fixed to the corresponding hook portion 55. In this manner, the winding-end lead wire 35 is fixed while receiving tension.

### Operation of the Embodiment

Operation of the present embodiment will now be described.

The input current from the power supply 42 flows to the winding-start lead wire 34 of the coil 28 of each phase via the corresponding connection terminal 41. In this manner, when the input current flows through the coil 28 of each phase, the rotor 12 and the rotary shaft 14 rotate integrally.

### Advantages of the Embodiment

The above-described embodiment has the following advantages.
(1) The coil 28 of each phase includes four spool portions 30, which are formed by the corresponding winding 31 wound in a concentrated manner around every third one of the teeth 25 in the circumferential direction of the yoke 24. Two coil sets 33 are defined in the coil 28 of each phase. Each of the two coil sets 33 is formed by connecting in series two of the four spool portions 30 that are disposed with two teeth 25 interposed therebetween in the circumferential direction of the yoke 24 via the connection wire 32. The coil 28 of each phase is formed by connecting the two coil sets 33 in parallel. All the connection wires 32 of the three-phase coils 28 extend in the same direction in the circumferential direction of the yoke 24 from one to the other of the two spool portions 30 forming the corresponding coil set 33. The winding-start lead wires 34 of the three-phase coils 28 are respectively led out from spool portions 30 that are wound around teeth 25 with one tooth 25 interposed therebetween in the circumferential direction of the yoke 24. The winding-end lead wires 35 of the three-phase coils 28 are electrically connected to one another to form a neutral point. With this configuration, the maximum number of the connection wires 32 of the three-phase coils 28 that overlap with one another in the axial direction of the yoke 24 is only two. This structure avoids locations where three connection wires 32 would otherwise overlap in the axial direction of the yoke 24. Therefore, the axial dimension of the yoke 24 in the stator 11 is reduced.
(2) The start of winding of each spool portion 30 is fixed as a result of the winding 31 being wound around the corresponding tooth 25. Therefore, it is not necessary to fix the winding-start lead wire 34 in order to prevent loosening of the start of winding of the spool portion 30. On the other hand, in order to prevent loosening of the end of winding of the spool portion 30, it is necessary to fix the winding-end lead wire 35.

In general, each winding 31 includes a conductive wire 31a and a coating 31b provided on the outer circumference of the conductive wire 31a. When the winding 31 is to be fixed to the hook portion 55, the outer circumference of the coating 31b is preferably covered in advance with an insulating member 31c. This prevents the coating 31b from being damaged and exposing the conductive wire 31a.

Consideration is also given to a case in which a neutral point is formed by electrically connecting lead wires, which are portions of the windings 31 led out from the spool portions 30 of the three-phase coils 28. In such a case, the lead wires of the three-phase coils 28 that form the neutral point require electrical insulation at the connection. Accordingly, it is preferable that the outer circumferences of the coatings 31b of the lead wires be covered in advance with the insulating members 31c.

Accordingly, in a configuration in which the neutral point is formed using winding-end lead wires 35 and the winding-end lead wires 35 include the insulating members 31c, the insulation required when connecting the winding-end lead wires 35 to one another to form the neutral point also ensures insulation when the winding-end lead wires 35 are fixed to the hook portions 55. This configuration is therefore preferable.

When the winding-start lead wires 34 are lead wires forming a neutral point, it is necessary to cover the outer circumferences of the coatings 31b of the winding-start lead wires 34 in advance with insulating members 31c. Furthermore, since the winding-end lead wires 35 also need to be fixed to the hook portions 55 as described above, it is necessary to cover the outer circumferences of the coatings 31b of the winding-end lead wires 35 in advance with the insulating members 31c. Therefore, it is necessary to cover the outer circumferences of the coatings 31b of both the winding-start lead wires 34 and the winding-end lead wires 35 with insulating members 31c. This complicates the configuration.

In view of the above, the winding-end lead wires 35 of the three-phase coils 28 are electrically connected to one another to form a neutral point. With this configuration, it is not necessary to cover the outer circumferences of the coatings 31b of the winding-start lead wires 34 of the three-phase coils 28 with the insulating members 31c in advance, and it is sufficient to cover the outer circumferences of the coatings 31b of the winding-end lead wires 35 of the three-phase coils 28 in advance with the insulating members 31c. Consequently, compared to a configuration in which the outer circumferences of the coatings 31b of both the winding-start lead wires 34 and the winding-end lead wires 35 of the three-phase coils 28 are covered with the insulating members 31c, an increase in structural complexity is avoided. Accordingly, the axial dimension of the yoke 24 in the stator 11 is reduced without complicating the structure.
(3) For example, consideration is given to a case in which the connection wires 32 of the coil 28 of one of the three phases are led out across the second core end face 23b toward the second side in the axial direction of the yoke 24, and extend in the circumferential direction of the yoke 24 while passing along the second side in the axial direction across the second core end face 23b. In such a case, the number of turns of the winding 31 in the spool portions 30 forming the coil 28 of one of the three phases differs from the number of turns of the windings 31 in the spool portions 30 forming the coils 28 of the other phases. As a result, the magnetic balance of the entire stator 11 becomes unstable, which may lead to deterioration in the motor performance. In this regard, the connection wire 32 of the coil 28 of each phase is led out across the first core end face 23a to the first side in the axial direction of the yoke 24, and extends in the circumferential direction of the yoke 24 while passing along the first side in the axial direction across the first core end face 23a. With this configuration, the number of turns of the windings 31 in the spool portions 30 forming the coil 28 of each phase is made uniform. Consequently, the magnetic balance of the entire stator 11 is stabilized, and the motor performance is improved.
(4) The connection wire 32 of each coil set 33 is guided in the circumferential direction of the yoke 24 while being received in the connection wire receiving groove 61. Therefore, the connection wires 32 are allowed to extend in the circumferential direction of the yoke 24 in a state in which insulation between the connection wires 32 that overlap in the axial direction of the yoke 24 is ensured. For example, consideration is given to a case in which the connection wires 32 overlap in the axial direction of the yoke 24, and there are locations where three connection wires 32 overlap in the axial direction of the yoke 24. Unlike such a configuration, the present embodiment does not require formation of three connection wire receiving grooves 61 on the outer circumferential surface of the insulator base 51. These grooves would otherwise need to be arranged side-by-side in the axial direction of the insulator base 51 and extend in the circumferential direction of the yoke 24. This configuration of the embodiment reduces the length of the insulator base 51 in the axial direction. As a result, the axial dimension of the insulator base 51 in the insulator 50 is reduced. Therefore, the axial dimension of the yoke 24 in the stator 11 is reduced.
(5) The winding-end lead wires 35 of the three-phases coils 28 are led out toward the second side in the axial direction of the yoke 24 across the second core end face 23b and are electrically connected to one another to form a neutral point. The winding-start lead wires 34 of the three-phase coils 28 are led out toward the second side in the axial direction of the yoke 24 across the second core end face 23b, and are connected to the power supply 42. Accordingly, it is possible to prevent the connection wires 32 from interfering with the operation of forming a neutral point with the winding-end lead wires 35 of the three-phase coils 28, or with the operation of connecting the winding-start lead wires 34 to the power supply 42. As a result, the formation of the neutral point with the winding-end lead wires 35 of the three-phase coils 28, as well as the connection of the winding-start lead wire 34 to the power supply 42, can be carried out smoothly.

### Modifications

The above-described embodiment may be modified as follows. The above-described embodiment and the following modifications can be combined if the combined modifications remain technically consistent with each other.

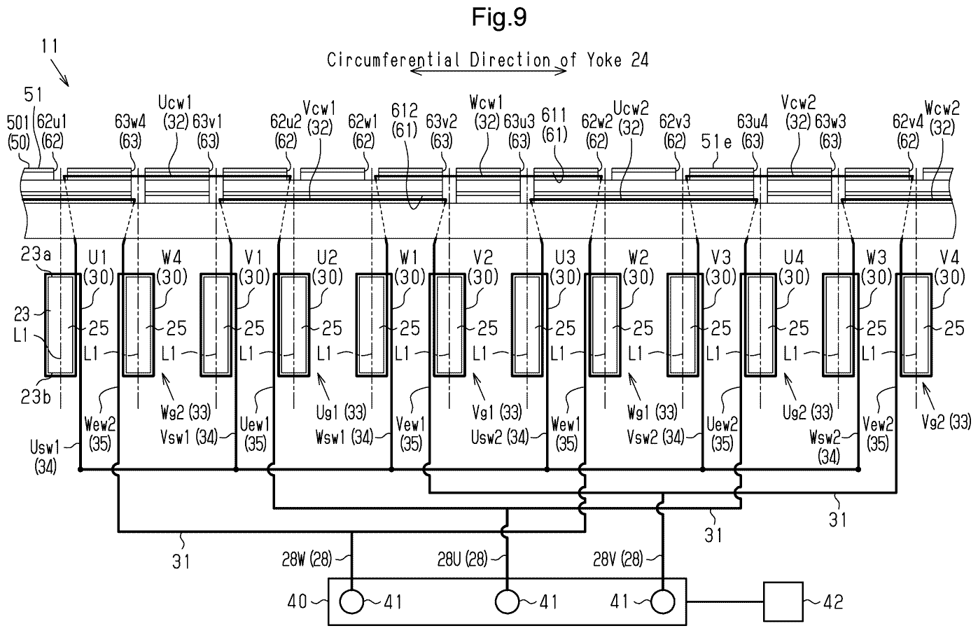

As shown in FIG. 9, the winding-start lead wires 34 of the three-phase coils 28 may be electrically connected to one another to form a neutral point. It is sufficient that either the winding-start lead wires 34 of the three-phase coils 28 or the winding-end lead wires 35 of the three-phase coils 28 are electrically connected to one another to form a neutral point.

Since each winding-end lead wire 35 is simply led out from the end of winding of the corresponding spool portion 30, the winding-end lead wire 35 is unlikely to come into contact with other parts of the spool portion 30. In contrast, when each winding-start lead wire 34 is led out from the corresponding spool portion 30, the winding-start lead wire 34 is likely to come into contact with the end of winding of the spool portion 30.

When a voltage is applied to each coil set 33 by feeding power, the voltage applied to the spool portion 30 on the downstream side in the power feeding direction of the two spool portions 30 forming the coil set 33 is lower than the voltage applied to the spool portion 30 on the upstream side in the power feeding direction. In other words, the voltage applied to the spool portion 30 closer to the neutral point of the two spool portions 30 forming the coil set 33 is lower. According to the inventors' verification, approximately 20% to 30% of the total voltage applied to each coil set 33 is applied to the spool portion 30 near the neutral point, while the remaining approximately 70% to 80% is applied to the upstream-side spool portion 30 in the power feeding direction. Accordingly, when the winding-start lead wires 34 of the three-phase coils 28 are electrically connected to one another to form a neutral point, the voltage applied to the spool portion 30 from which the winding-start lead wire 34 is led out is lower than the voltage applied to the spool portion 30 from which the winding-end lead wire 35 is led out. In this regard, the winding-start lead wires 34 of the three-phase coils 28 are electrically connected to one another to form a neutral point. Accordingly, even if the winding-start lead wire 34 comes into contact with the end of winding of the spool portion 30 when the winding-start lead wire 34 is led out from the spool portion 30, the potential difference between the winding-start lead wire 34 and the end of winding of the spool portion 30 is kept small. Consequently, the dielectric strength of the coils 28 is improved, and the reliability of the stator 11 of the rotating electric machine 10 is improved.

In the embodiment, the connection wires 32 of the coil 28 of one of the three phases may be led out across the second core end face 23b toward the second side in the axial direction of the yoke 24, and may extend in the circumferential direction of the yoke 24 while passing along the second side in the axial direction across the second core end face 23b. Even in this case, it is sufficient that all the connection wires 32 of the three-phase coils 28 extend in the same direction in the circumferential direction of the yoke 24 from one to the other of the two spool portions 30 forming a coil set 33.

In the embodiment, the winding-end lead wires 35 of the three-phase coils 28 may be led out toward the first side in the axial direction of the yoke 24 across the first core end face 23a and electrically connected to one another.

In the embodiment, the winding-start lead wires 34 of the three-phase coils 28 may be led out toward the first side in the axial direction of the yoke 24 across the first core end face 23a and connected in parallel with each other.

In the embodiment, the coil 28 of each phase may include four or more spool portions 30. It is sufficient that the coil 28 of each phase is formed by defining multiple coil sets 33 in the coil 28 of each phase and connecting the coil sets 33 in parallel with each other. Each of the coil sets 33 is formed by connecting in series two of the four or more spool portions 30 that are disposed such that two teeth 25 are present therebetween in the circumferential direction of the yoke 24 via the corresponding connection wire 32. In the embodiment, the rotor 12 is disposed inside the stator 11, but the stator 11 may be disposed inside the tubular rotor 12. In this case, the teeth 25 extend outward in the radial direction of the yoke 24 from the outer circumferential surface, which is a circumferential surface of the yoke 24. It is sufficient that the teeth 25 extend in the radial direction of the yoke 24 from a circumferential surface of the yoke 24. When the stator 11 is disposed inside the rotor 12, two connection wire receiving grooves 61 are formed in the inner circumferential surface 51a, which is a circumferential surface of the insulator base 51. It is sufficient that two connection wire receiving grooves 61 are formed in the circumferential surface of the insulator base 51.

In the embodiment, each of the winding-end lead wires 35 fixed to the hook portions 55 may be in a tension-free state. That is, each winding-end lead wire 35 may be fixed to the hook portion 55 in any manner that prevents loosening of the end of winding of the spool portion 30.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuitry are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A stator for a rotating electric machine, the stator comprising:
three-phase coils; and
a stator core including a tubular yoke and multiple teeth arranged to be spaced apart from each other in a circumferential direction of the yoke, each of the teeth extending from a circumferential surface of the yoke in a radial direction of the yoke, wherein
the coil of each phase includes:
four or more spool portions formed by a winding wound in a concentrated manner around every third one of the teeth in the circumferential direction; and
a connection wire, a winding-start lead wire, and a winding-end lead wire, which are portions of the winding,
multiple coil sets are defined in the coil of each phase, each of the multiple coil sets being formed by connecting two of the four or more spool portions in series via the connection wire, the two spool portions being arranged such that two of the teeth are present therebetween in the circumferential direction, and
the coil of each phase is formed by connecting the multiple coil sets in parallel,
in the coil of each phase, the winding-start lead wire is led out from one of the two spool portions forming the coil set, and the winding-end lead wire is led out from the other of the two spool portions forming the coil set,
all the connection wires of the three-phase coils extend in the same direction along the circumferential direction from one to the other of the two spool portions forming the coil set,
the winding-start lead wires of the three-phase coils are respectively led out from spool portions that are wound around teeth with one tooth interposed therebetween in the circumferential direction, and
the winding-start lead wires of the three-phase coils or the winding-end lead wires of the three-phase coils are electrically connected to each other to form a neutral point.

2. The stator for the rotating electric machine according to claim 1, wherein the winding-end lead wires of the three-phase coils are electrically connected to each other to form a neutral point.

3. The stator for the rotating electric machine according to claim 1, wherein the winding-start lead wires of the three-phase coils are electrically connected to each other to form a neutral point.

4. The stator for the rotating electric machine according to claim 1, wherein
the stator core includes a first core end face that is an end face located at a first side in an axial direction of the yoke, and
the connection wire of the coil of each phase is led out toward the first side in the axial direction across the first core end face, and extends in the circumferential direction while passing along the first side in the axial direction across the first core end face.

5. The stator for the rotating electric machine according to claim 4, further comprising an insulator disposed to face the first core end face and providing insulation between the coils and the first core end face, wherein
the insulator includes a tubular insulator base disposed at a position overlapping with the yoke in the axial direction,
two connection wire receiving grooves are formed in a circumferential surface of the insulator base, the connection wire receiving grooves being arranged side by side in an axial direction of the insulator base and extending in the circumferential direction,
one of the two connection wire receiving grooves receives the connection wire of one coil set and guides that connection wire in the circumferential direction, and
the other of the two connection wire receiving grooves guides, in the circumferential direction, a connection wire of another coil set, which includes a spool portion that is located, with one spool portion interposed therebetween, in the circumferential direction relative to the spool portion from which the winding-start lead wire of the one coil set is led out, while receiving the connection wire.

6. The stator for the rotating electric machine according to claim 4, wherein
the stator core includes a second core end face that is an end face located at a second side in the axial direction of the yoke, and
the winding-start lead wire and the winding-end lead wire of the coil of each phase are led out toward the second side in the axial direction across the second core end face.
